(19) United States
(12) Patent Application Publication
(10) Pub. No.: US 2010/0088299 A1
(43) Pub. Date: Apr. 8, 2010

(54) AUTONOMIC SUMMARIZATION OF CONTENT

(76) Inventors: Patrick J. O'Sullivan, Dublin (IE); Carol S. Zimmet, Boxborough, MA (US); Hema Srikanth, Raleigh, NC (US)

Correspondence Address: MOORE & VAN ALLEN, PLLC For IBM, P.O. Box 13706, Research Triangle Park, NC, 27709, US

(21) Appl. No.: 12/245,799

(22) Filed: Oct. 6, 2008

(51) Int. Cl. G06F 17/30

(52) U.S. Cl. 707/705; 707/E17.135; 707/E17.108

(57) ABSTRACT

Autonomic summarization of content may include receiving information regarding an action, generating metadata content related to the action, storing the metadata content, and performing a search of the stored metadata content to find information on the performed action. Also included is an apparatus for autonomic summarization of content including a summarization engine, the summarization configured to autonomically generate meta data related to an activity, a repository, the repository configured to store the generated meta data, and a processor, the processor configured to receive a query and use the query to search for meta data associated with the activity.

### BACKGROUND OF THE INVENTION

The present invention is related to summarizing content, and more specifically to autonomic summarization of content.

Situations arise where a user is trying to find content that they've used or have accessed at sometime in the past (e.g., a few weeks, a month or more, a year, etc.) and they struggle to find it again. The content may have been from a webpage on the Internet, a document in a document library, a record in the user's personal journal, an email that the user read, an email that the user sent, a Portable Document Format (PDF) or word processor document on the user's desktop, etc. (i.e., any kind of content).

For example, a user may have been surfing the Internet four months ago where the user found some arbitrary article on some topic that the user needed for his work. The user needs the same data for a problem the user is trying to solve today. Unfortunately, the user cannot recall the complex search engine search string he used and spends thirty minutes trying to find the same topic. In another example, a user may recall seeing a document on a particular subject. The user has no idea as to whether she saw this document in an email, a content repository, the Internet, a journal, etc. The user wants to reference this document again. However, the user has no idea where to start in terms of finding it, so the user starts painstakingly all over again searching for the document. In still another example, some time ago, a user had an exchange with someone (the user does not recollect who) on some topic of interest. The user is not sure if it was in an email or a team room. The user is trying to recover that interaction so that the data shared can be surfaced again. The information actually may have surfaced in an instant message (IM) chat, however, the user forgot. The user therefore never finds the information.

### BRIEF SUMMARY OF THE INVENTION

According to one aspect of the present invention, a method for autonomic summarization of content includes performing an action by a person receiving information related to an action, generating meta data content related to the action, storing the metadata content, receiving a query related to the action, performing a search of the stored meta data content to identify meta data content related to the query, and providing the identified meta data.

According to another aspect of the present invention, an apparatus for autonomic summarization of content that includes a summarization engine, the summarization configured to autonomically generate meta data related to an action, a repository, the repository configured to store the generated meta data, and a processor, the processor configured to receive a query and use the query to search for meta data associated with the action.

According to a further aspect of the present invention, a computer program product comprising a computer useable medium having computer useable program code embodied therewith, the computer useable program code comprising computer useable program code configured to perform an action by a person receive information related to an action by a person, computer useable program code configured to generate metadata content related to the action, computer useable program code configured to store the metadata content, computer useable program code configured to receive a query related to the action, computer useable program code configured to perform a search of the stored meta data content to identify meta data content related to the query, and computer useable program code configured to provide the identified meta data.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a flowchart of a process for autonomic summarization of content according to an example embodiment of the present invention;

FIG. 2 is a flowchart of a process for autonomic summarization of content according to another example embodiment of the present invention;

FIG. 3 is a flowchart of a process for retrieving meta data according to an example embodiment of the present invention;

FIG. 4 is a flowchart of a process for storing meta data from multiple persons according to an example embodiment of the present invention;

FIG. 5 is a flowchart of a process for retrieving meta data related to an action according to an example embodiment of the present invention; and

FIG. 6 is a diagram of a system for autonomic summarization of content according to an example embodiment of the present invention

### DETAILED DESCRIPTION OF THE INVENTION

As will be appreciated by one of skill in the art, the present invention may be embodied as a method, system, computer program product, or a combination of the foregoing. Accordingly, the present invention may take the form of an entirely hardware embodiment, an entirely software embodiment (including firmware, resident software, micro-code, etc.) or an embodiment combining software and hardware aspects that may generally be referred to herein as a “system.” Furthermore, the present invention may take the form of a computer program product on a computer-usable storage medium having computer-usable program code embodied in the medium.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device; or transmission media such as those supporting the Internet or an intranet. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer usable or computer readable medium may be any medium that can contain, store, communicate, propagate, or transport the program for use by or in connection with the instruction execution system, platform, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented, scripted or unscripted programming language such as Java, Perl, Smalltalk, C++ or the like. However, the computer program code for carrying out operations of the present invention may also be written in conventional procedural programming languages, such as the “C” programming language or similar programming languages.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

Embodiments according to the present invention allow capturing of information in a content repository that is associated with a user. Meta activity for things that the user does during a day may get recorded in the content repository in a very brief form. The information captured may be linked to content that already exists, but with enough meta information to satisfy a search allowing the user to answer the question, “where did I see that before?”

According to embodiments of the present invention, one or more content repositories may reside on a server where the one or more content repositories serve a plurality of users. In other embodiments according to the present invention, a content repository may reside on a user's machine (e.g., client device) and may be specific for that user. In still other embodiments of the present invention, a hybrid implementation may exist where a server maintains a specific number of content repositories for the same number of users and each client device maintains one content repository for its associated user where each user's content repository may be replicated or synchronized with the content repository on the server. The synchronization may occur at intervals that are decided by a system user/administrator or by other methods.

Moreover, according to embodiments of the present invention, summarization engines may be used to generate meta data. This allows an item of content to be defined in a few short lines. The summarization engines may generate meta data for the purposes of summarization, where the meta data may include any type of information such as, for example, a title, a brief abstract, key words, individuals involved, episode date (e.g., when did the user see it?), application type (e.g., email, IM, word processor, browser, etc.), etc. In embodiments according to the present invention, autonomic/silent/passive summarization may be used as well as active summarization. In active summarization, at the end of each significant event a user may be prompted to store information regarding the event. In an active summarization, a set of preferences may be defined for ease of use to the user. For example, preferences may be a set of rules that help a user handle specific content or situations such as, for example, always summarize web pages, prompt the user for summarization of IM chats, always summarize emails the user receives but prompt the user for auto summarization of emails that the user sends, etc.

According to embodiments of the present invention, an interface may exist to allow a user to interrogate the content repository on their workstation/client device, a server, or both. This allows a search across the vertical application types or specific applications that the user may want to identify. Further, since storage space may be expensive, embodiments of the present invention may highly compress meta data associated with the user on either the client device or server or both.

Moreover, according to embodiments of the present invention, repeat viewing of content may be captured and presented to a user. For example, if a user opened a word processor or PDF document five times, then in the course of searching for this document later, the user may be reminded that the user had accessed this document five times. This may apply for web pages, and other content that the user may have seen or accessed repeated times.

In addition, according to embodiments of the present invention, a user may interrogate/query content or information from another user, or a plurality of other users. Permissions may exist on some or all of the content or information form other users requiring each user to have the appropriate permission before access is allowed to interrogate/query content from other users. Also, content from other users may be freely obtainable to all users. For example, a repository containing content from a plurality of users may be searched by one user and all related content stored in the repository may be presented to the user where the related content may be from a plurality of different users. Similarly, queries used for searching by one user may be accessed and used by other users thereby optimizing a search for the second user. The second user may review the results returned as well as may execute the query to refresh the information for more current results if desired.

As noted previously, according to embodiments of the present invention, content may be obtained manually where a user may be prompted to enter query or other information for searching for the required content, or content may be obtained autonomically. When content is obtained autonomically, this may be by a machine, or a process, or combination thereof, that has some intelligence in decision making where rules may be used to determine how to build meta data for a user. Further, information from a user's background may also be used as well as a history of past activities by the user to create rules. These rules may be used by a summarization engine to build meta data for a user based on a current activity. For example, rules may be generated based on a frequency of words used, the size of words, a user's background, the content of an email, how many times content has been accessed, etc. These may be used to predict, estimate or determine for a user, what the meta data should be. If no rules exist, a typical summarization may be used to generate meta data for a current activity.

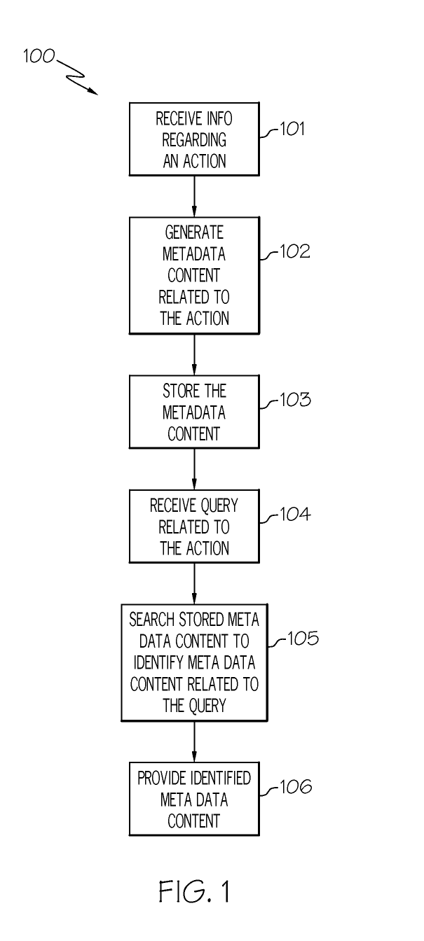

FIG. 1 shows a flowchart of a process for autonomic summarization of content according to an example embodiment of the present invention. In the process 100, in block 101, information regarding an action may be received. In block 102, meta data content related to the action may be generated. In block 103, the meta data content may be stored. In block 104, a query related to the action may be received. In block 105, a search of the stored meta data content may be performed to identify meta data content related to the query. In block 106, the identified meta data may be provided or made available.

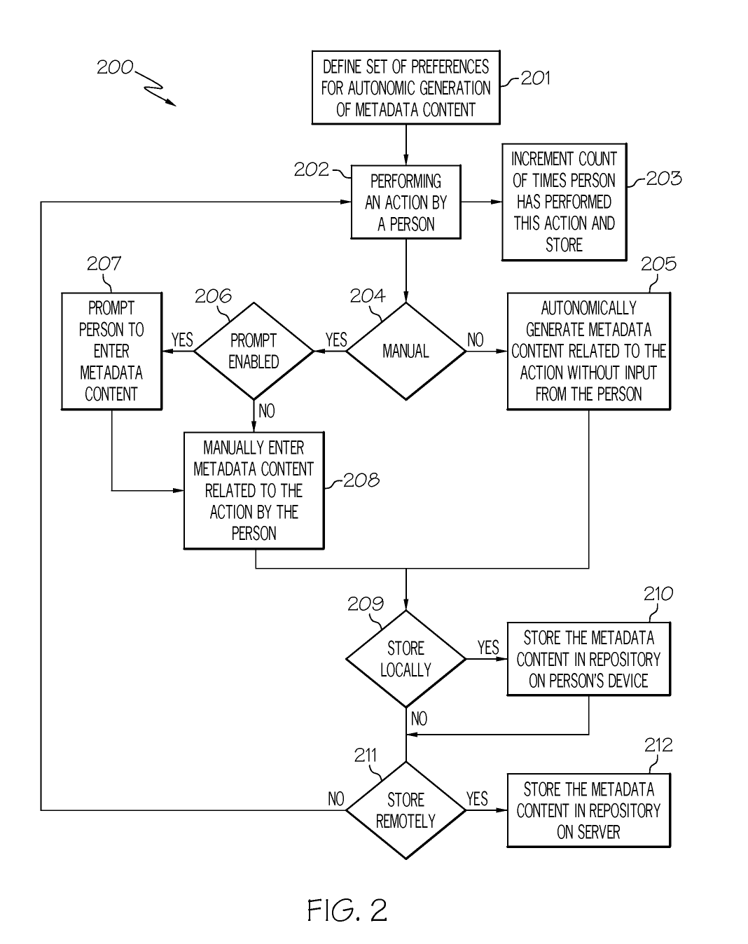

FIG. 2 shows a flowchart of a process for autonomic summarization of content according to another example embodiment of the present invention. In the process 200, in block 201, a set of preferences for autonomic generation of meta data content may be defined. In block 202, an action may be performed by a person. In block 203, a count of times the person has performed this action may be incremented and stored. In block 204, it may be determined if manual generation of meta data content is desired and if not, meta data content related to the action may be autonomically generated without input from the person. If manual generation is desired, then in block 206, it may be determined if prompting the user is enabled and if so, then in block 207 a prompt may be issued to the user to enter meta data content and then in block 208, the user may enter manually meta data content related to the action by the person. If prompting is not enabled, then in block 208, the user may manually enter the meta data content related to the action by the person. Once the meta data has been generated either manually or autonomically, then in block 209, it may be determined whether the meta data content should be stored locally, and if so, then in block 210, the meta data content may be stored in a repository on the person's device (e.g., client device). In block 211, it may be determined whether it is desired to store the meta data content remotely, and if not, the process returns to block 202 where an action by a person may be performed. If it is desired to store the meta data content remotely, then in block 212, the meta data content may be stored in a repository on a server or other remote storage device.

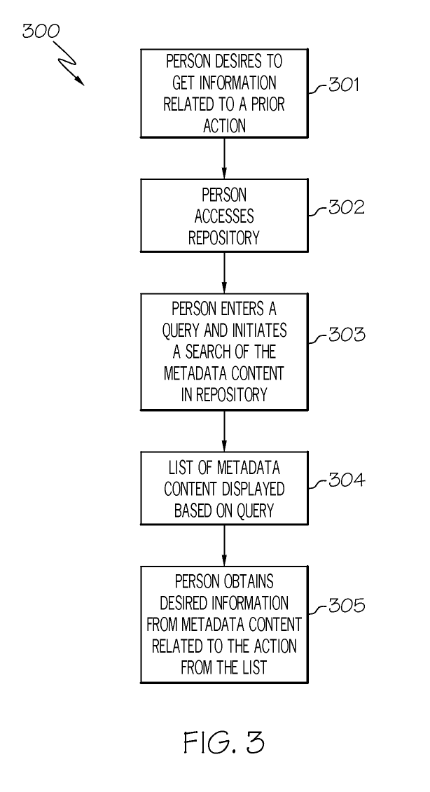

FIG. 3 shows a flowchart of a process for retrieving meta data according to an example embodiment of the present invention. In the process 300, in block 301, a person may desire to get information related to a prior action. In block 302, the person may access a repository. The repository may reside locally or may at a remote device. In block 303, the person may enter a query and initiate a search of the meta data content in the repository. In block 304, a list of meta data content related to the inquiry may be displayed. In block 305, the user may obtain the desired information from meta data content related to the action from the displayed list.

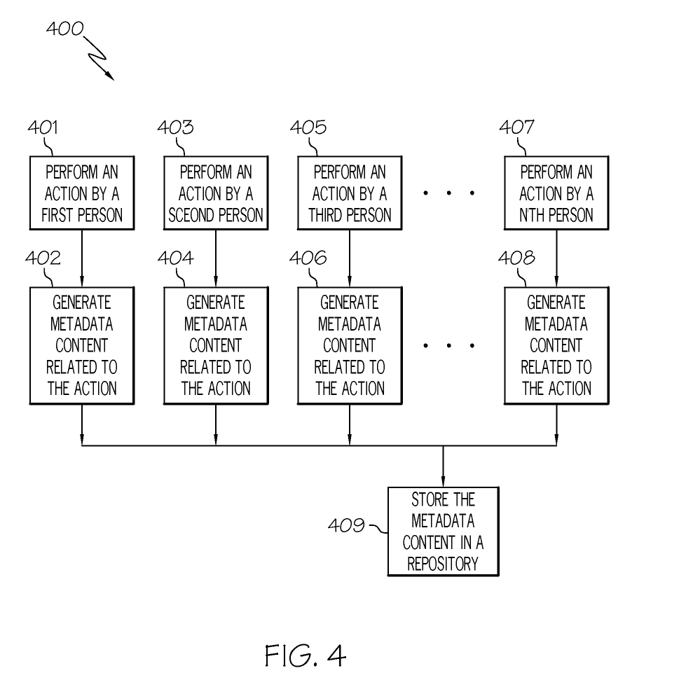

FIG. 4 shows a flowchart of a process for storing meta data from multiple persons according to an example embodiment of the present invention. In the process 400, in block 401, an action may be performed by a first person and then in block 402, meta data content related to the action may be generated. In block 403, an action may be performed by a second person and then in block 404, meta data content related to the action may be generated. In block 405, an action may be performed by a third person and then in block 406 meta data content related to the action may be generated. Similarly, in block 407, an action may be performed by one or more n^{th} person and then in block 408, meta data content related to the action may be generated. In block 409, meta data content generated by all persons may be stored in a single repository. Therefore, any person may generate a query related to an action, submit the query to the repository, and be presented with a list of related meta data content from one or more persons.

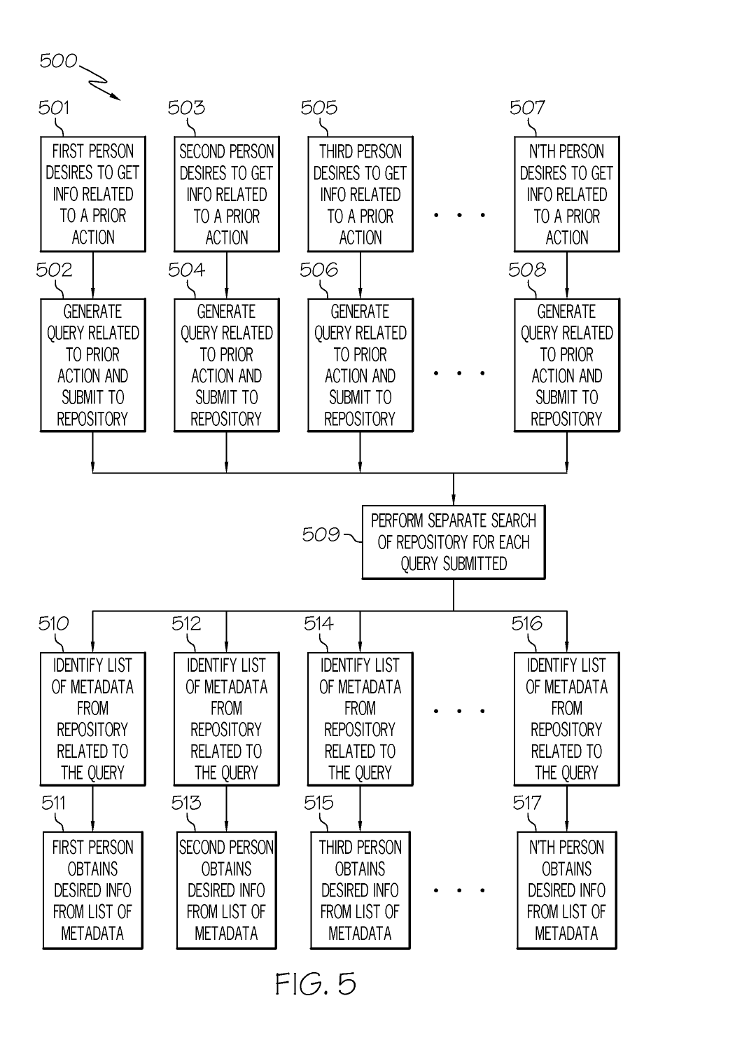

FIG. 5 shows a flowchart of a process for retrieving meta data related to an action according to an example embodiment of the present invention. In the process 500, in block 501, a first person desires to get information related to a first prior action. Then in block 502, a first query may be generated related to the first prior action and submitted to a repository. In block 503, a second person may desire to get information related to a second prior action and in block 504 a second query may be generated related to the second prior action and be submitted to a repository. In block 505, a third person may desire to get information related to a third prior action and in block 506 a third query may be generated related to the third prior action and be submitted to a repository. Similarly, in block 507, one or more n^{th} persons may desire to get information related to an nth prior action and in block 508, a nth query related to the nth prior action may be generated and submitted to a repository. In block 509, a separate search of a repository may be performed for each query submitted by each person.

In block 510, a list of meta data from the repository related to the first query may be identified and in block 511, the first person may obtain the desired information from the list of meta data. In block 512, a list of meta data from the repository related to the second query may be identified and in block 513, the second person may obtain the desired information from the list of meta data. In block 514, a list of meta data from the repository related to the third query may be identified and in block 515, the third person may obtain the desired information from the list of meta data. Similarly, in block 516, a list of meta data from the repository related to the nth query may be identified and in block 517, the one or more n^{th} person may obtain the desired information from the list of meta data.

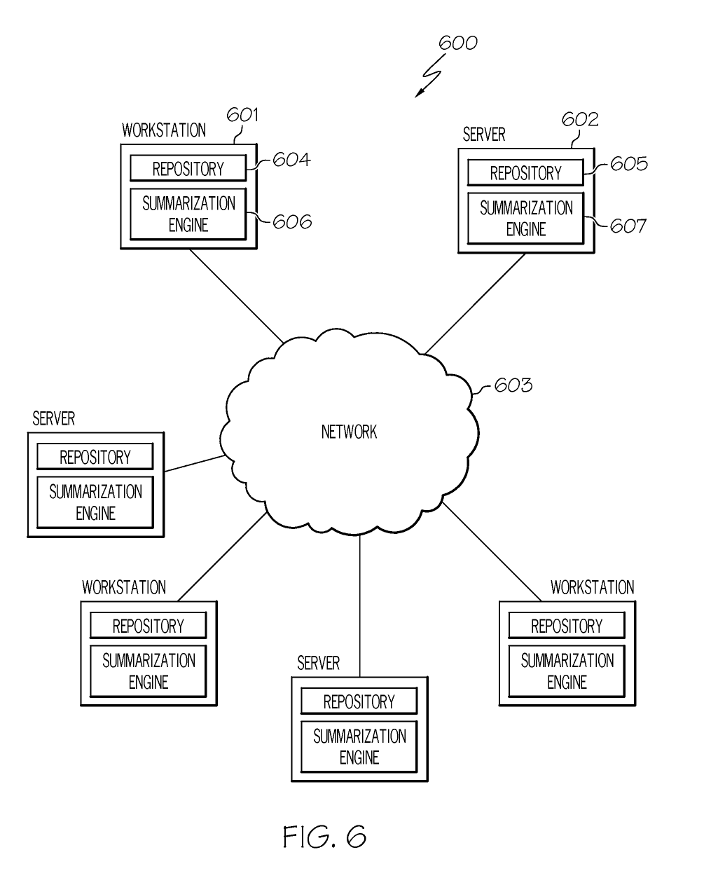

FIG. 6 shows a diagram of a system for autonomic summarization of content according to an example embodiment of the present invention. The system may include one or more client devices/workstations 601 that may be operatively connected to one or more servers 602 via a network 603, e.g., the Internet. Although not shown, each workstation 601 may include typical workstation features such as, for example, a processor, an input device, a display device, a network interface, a memory, etc. A user at a workstation 601 may either manually or autonomically generate meta data related to an activity of the user. Meta data may be generated manually may be input by the user using an input device on his own or in response to prompts being displayed on a display at the workstation 601. Meta data may be generated autonomically by a summarization engine 606 at the workstation 601 where a user may provide little or no input. The generated meta data may be stored in a repository 604 at the client device and/or in a repository 605 that resides on a server 602. The repository 605 at the server 602 may contain meta data generated from a plurality of users and/or workstations 601. Moreover, a user may enter a query at a workstation 601 to search the repository 604 at a client device 601 and/or a repository at 605 at a server 602 to retrieve a list of meta data associated with the entered query. A user may review this list to help identify a way to access content related to the query. Moreover, according to embodiments of the present invention, meta data may be generated autonomically by a summarization engine 607 at a server 602. Although not shown, each server 602 may include typical server features such as, for example, a processor, an input device, a display device, a network interface, a memory, etc. Each server may also include an interface, the interface being configured to receive information related to the action that may be used to generated meta data, and to receive the query. The interface may be a network interface or any other type of interface for allowing receiving and/or transmitting of information. The interface may be used to provide the list of meta data associated with the entered query to the user.

Although not shown, embodiments according to the present invention may include additional deployment configurations such as, for example, multiple networks, cell phone interfaces, cellular network bridge, etc., where a user at a workstation 601 may either manually or autonomically generate meta data related to an activity of the user using one or more of the additional deployment configurations.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for autonomic summarization of content comprising:
receiving information related to an action;
generating meta data content related to the action;
storing the meta data content;
receiving a query related to the action;
performing a search of the stored meta data content to identify meta data content related to the query; and
providing the identified meta data.

2. The method according to claim 1, the meta data comprising information related to one of a web page access, an Instant Message (IM) chat session, an email that was read, an email that was sent, search criteria entered in a search engine, a conversation, reading, writing, a Short Message Service (SMS) message that was received, a SMS message that was sent, or a document that was opened.

3. The method according to claim 1, further comprising generating the meta data content autonomically without human input.

4. The method according to claim 3, further comprising generating the meta data content autonomically using a summarization engine.

5. The method according to claim 4, further comprising receiving a set of preferences usable by the summarization engine to generate the meta data content.

6. The method according to claim 5, wherein the received set of preferences comprise at least one of summarize web pages, prompt user for summarization of instant messaging (IM) chat sessions, summarize instant messaging (IM) chat sessions, summarize received emails, prompt user for automatic summarization of sent emails, summarize sent emails, and prompt user for automatic summarization of received emails.

7. The method according to claim 1, wherein the meta data content comprises at least one of a title, an abstract, a keyword, an individual's name, a date, a description, an application type, a universal resource locator (URL), a telephone number or an email address.

8. The method according to claim 1, further comprising generating the meta data content related to the action in response to a prompt to enter the metadata content.

9. The method according to claim 1, further comprising storing the meta data content in at least one of a content repository on a client device and a content repository on a server.

10. The method according to claim 9, further comprising storing meta data content of a plurality of persons in the content repository on the server, and providing access to all the meta data content of the plurality of persons to the plurality of persons.

11. The method according to claim 9, further comprising periodically synchronizing the meta data content stored in the content repository on the client device with the meta data content stored in the content repository on the server.

12. The method according to claim 1, further comprising capturing repeat occurrences of performing the action and providing a message regarding the repeat occurrences in response to a search of the stored meta data content.

13. The method according to claim 1, further comprising storing queries from prior searches by a plurality of persons for the performed action, the stored queries being accessible and useable by the plurality of persons.

14. An apparatus for autonomic summarization of content comprising:
a summarization engine, the summarization engine being configured to autonomically generate meta data related to an action;
a repository, the repository configured to store the generated meta data; and
a processor, the processor configured to receive a query and use the query to search for meta data associated with the action.

15. The apparatus according to claim 14, further comprising an interface, the interface being configured to receive information related to the action and to receive the query.

16. The apparatus according to claim 14, further comprising the processor being configured to generate a list of meta data found as a result of the search.

17. A computer program product comprising a computer useable medium having computer useable program code embodied therewith, the computer useable program code comprising:
computer useable program code configured to receive information related to an action;
computer useable program code configured to generate meta data content related to the action;
computer useable program code configured to store the meta data content;
computer useable program code configured to receive a query related to the action;
computer useable program code configured to perform a search of the stored meta data content to identify meta data content related to the query; and
computer useable program code configured to provide the identified meta data

18. The computer program product according to claim 17, further comprising computer useable program code configured to generate a prompt to enter the meta data content.

19. The computer program product according to claim 17, further comprising computer useable program code configured to store the meta data content in at least one of a content repository on a client device or a content repository on a server.
